(19) United States
(12) Patent Application Publication
(10) Pub. No.: US 2015/0356082 A1
(43) Pub. Date: Dec. 10, 2015

(54) Product Recommendation Engine

(71) Applicant: William Lewis Perdue, Sonoma, CA (US)

(72) Inventor: William Lewis Perdue, Sonoma, CA (US)

(21) Appl. No.: 14/300,198

(22) Filed: Jun. 9, 2014

(51) Int. Cl. G06F 17/30; G06Q 30/06

(52) U.S. Cl. CPC G06F 17/30035; G06F 17/30522; G06Q 30/0631

(57) ABSTRACT

A recommendation engine is configured to provide a recommendation for a product within a set of products to a user belonging to a group of a plurality of users within a larger set of users each user having unique user identification information and each product having unique product identification information. Product reviews are obtained from the set of users for at least some of the products within the set of products. Reviews are stored in a database along with corresponding product identification information and the user identification information of the user providing the review. Each user within the set of users is allocated to a group within a plurality of groups based upon the product reviews provided by the users. A user is provided with a recommendation based upon the group the user is allocated to and the reviews provided by other members of the group.

### TECHNICAL FIELD

The present disclosure relates generally to a method and system for providing recommendations to users for products, services, business establishments and the like (collectively referred to herein as “products”).

### BACKGROUND

Recommendations are important to the marketing and sale of various types of non-commodity consumer products such as wine, cheese, movies, books, restaurants, electronics and the like. People often look to the experience of others in coming to a purchasing decision. A recurring problem with most recommendation-based systems is that they are almost always inaccurate because they are arbitrary and based upon the purely qualitative opinions of the recommender. This results in unsatisfactory recommendations because there are great difficulties in attempting to normalize the views of one person with those of another.

Consumers need an improved solution to the recommendation problem in order to help them purchase the most suitable product given their own preference structure which assuredly differs from most others' preference structures. Merchants need a better solution to offering recommendations because selling the right product to a consumer can increase sales and decrease costs related to customer service and product returns. Consumers who offer recommendations also need some degree of anonymity if they are to give honest reviews. Recent litigation has shown that courts are, where possible, willing to order the disclosure of reviewers' identification information which will have a chilling effect on the giving of honest negative reviews and undoubtedly unreasonably bias future reviews toward the positive where unjustified by the facts.

Some current recommendations systems include: (1) ‘Collaborative Filtering’—a system used by a number of on-line retailers. The system essentially notifies potential buyers of a first product of other products purchased by other potential buyers of the first product. This approach does not provide a scalar value as to the relative merit of the alternative or supplemental purchase(s) nor does it provide any sort of rating by the original buyer of the first product. (2) ‘Expert Opinions’—a system used by many retailers, particularly in the wine and food industries, to rate products with a scalar value (1-100, 1-5 stars, and the like) which purport to advise a potential customer of the relative merit of the product in question. If one's preferences are not in line with those of the so-called expert, however, the system is of little use as there is no known way to normalize one's personal preferences with those of the expert. (3) ‘User-Based Opinions’—a system recently promulgated over the Internet by vendors such as OpenTable.com, Yelp.com, Amazon.com and the like where purchasers of a product are encouraged to provide their impressions of the utility of the product in writing so that others may evaluate the product in light of the context of these impressions. Problems with this approach include: the size of the database that a potential purchaser would have to go through in order to see all the evaluations for a particular product; biases caused by the risk of litigation with respect to negative reviews as discussed above; and the “expert opinion” problem also discussed above.

One can more easily understand the issue by looking at a particular example. In the wine industry, for example, the customer buys fermented grape juice. But all fermented grape juice is not the same and essentially all of the value of wine is in the perceived taste. Since taste differs greatly among humans one wine might be perfectly good or even great to one group of people yet be perfectly awful to another. This problem of wine illustrates some of the issues associated with any product recommendation. This is because it is a complex product subject to personal taste and carries with it a relatively high degree of anxiety and uncertainty arising from genetic factors as well as culture, consumer friction, and the sheer challenge of description and recommendation.

Genetic variations and individual uniqueness stand in the way of most or all current recommendation systems for consumer items involving sensory preferences such as taste, smell, color, sound and tactile feel. Genetic variations show their greatest complications when wine and food preferences are at issue because they involve the interplay of smell and taste. Research has shown that people have inherent in-born differences. Some people cannot detect the bitter almond odor of cyanide compounds. Others cannot detect the presence in their urine of certain food metabolites such as those that follow eating asparagus or the theobromine in coffee. There is no assurance that two different people sensing the same thing will sense it in the same way. Language also poses problems is describing sensed characteristics as there is no clear way to accurately describe such sensed characteristics using language without extensive training and experience.

Cultural, ideological and philosophical variations cause the same recommendation problems when applied to products that are matters of intellectual taste such as movies, books and other thought-derived (as opposed to sensory-determined) preferences.

### OVERVIEW

The subject matter described herein generally relates to systems, methods and associated computer instructions for providing a recommendation engine with unique properties for providing recommendations of products to users, either on demand or automatically.

In summary, in one aspect a recommendation engine is configured to provide a recommendation for a product within a set of products to a user belonging to a group of a plurality of users within a larger set of users each user having unique user identification information and each product having unique product identification information. Product reviews are obtained from the set of users for at least some of the products within the set of products. Reviews are stored in a database along with corresponding product identification information and the user identification information of the user providing the review. Each user within the set of users is allocated to a group within a plurality of groups based upon the product reviews provided by the users. A user is provided with a recommendation based upon the group the user is allocated to and the reviews provided by other members of the group.

In another aspect the allocation of a user to a particular group and the formation of those groups may be carried out by various algorithms such as, but not limited to clustering algorithms and multi-dimensional distance algorithms.

In another aspect the creation of groups and allocation to users thereto may be performed periodically, e.g., as new data arrives, and may be constrained to target having certain numbers of groups or certain numbers of users within groups to achieve improved results.

The foregoing overview is a summary and thus may contain simplifications, generalizations, and omissions of detail; consequently those skilled in the art will appreciate that the overview is illustrative only and is not intended to be in any way limiting.

### BRIEF DESCRIPTION OF THE DRAWINGS

The accompanying drawings, which are incorporated into and constitute a part of this specification, illustrate one or more exemplary embodiments and, together with the description of the exemplary embodiments, serve to explain the principles and implementations of the invention.

In the drawings:

FIG. 1 is a system block diagram illustrating a computer system configured for implementing at least one of a method, a system and software in accordance with exemplary embodiments.

FIG. 2 is a system block diagram of a portion of a data communications network coupling a computer system to a user's computer.

FIG. 3 is a Venn diagram illustrating the universe of products, a subset of that universe and an individual product.

FIG. 4A is a process flow diagram illustrating the basic flow of the process detailed herein.

FIG. 4B is a process flow diagram illustrating the basic collection of data used in the process of FIG. 4A.

FIG. 4C is a process flow diagram illustrating the basic storage of data used in the process of FIG. 4A.

FIG. 4D is a process flow diagram illustrating the basis analysis of data used in the process of FIG. 4A.

FIG. 4E is a process flow diagram illustrating the basis recommendation process used in the process of FIG. 4A.

FIG. 5A is an exemplary simplified User-Product Data Matrix in accordance with an embodiment.

FIG. 5B is an Un-Normalized User-User Distance Matrix in accordance with an embodiment.

FIG. 5C is a matrix illustrating User In-Common Reviews in accordance with an embodiment.

FIG. 5D is a User-User Normalized Distance Matrix in accordance with an embodiment.

### DESCRIPTION OF EXAMPLE EMBODIMENTS

Exemplary embodiments are described herein in the context of a recommendation engine. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the exemplary embodiments as illustrated in the accompanying drawings. The same reference indicators will be used to the extent possible throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

References herein to “one embodiment” or “an embodiment” or “one implementation” or “an implementation” means that a particular feature, structure, part, function or characteristic described in connection with an exemplary embodiment can be included in at least one exemplary embodiment. The appearances of phrases such as “in one embodiment” or “in one implementation” in different places within this specification are not necessarily all referring to the same embodiment or implementation, nor are separate and alternative embodiments necessarily mutually exclusive of other embodiments.

In accordance with this disclosure, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

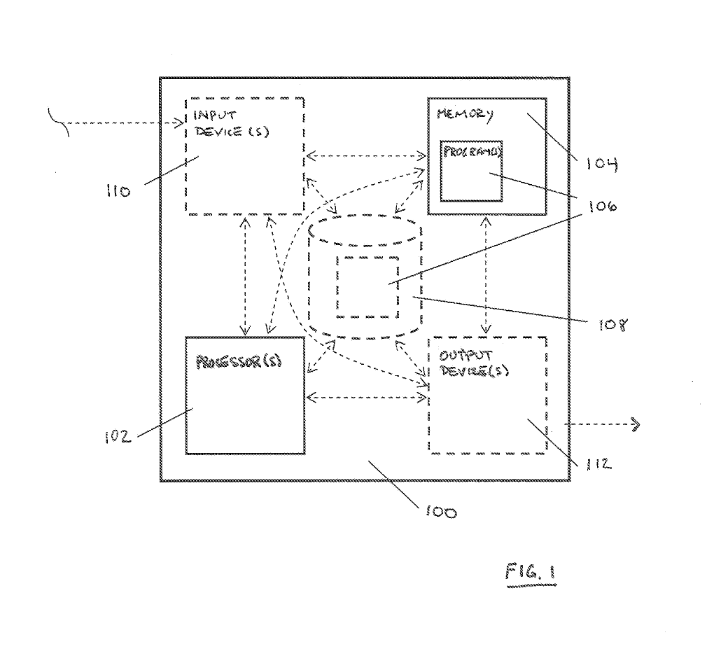

FIG. 1 is a system block diagram illustrating a computer system configured for implementing at least one of a method, a system and software in accordance with exemplary embodiments. FIG. 1 depicts a device or a computer system 100 comprising one or more processors 102 and a memory 104 storing one or more programs 106 for execution by the one or more processors 102.

In some embodiments, the device or computer system 100 can further comprise a non-transitory computer-readable storage medium 108 storing the one or more programs 106 for execution by the one or more processors 102 of the device or computer system 100.

In some embodiments, the device or computer system 100 can further comprise one or more input devices 110, which can be configured to send or receive information to or from any one from the group consisting of: an external device (not shown), the one or more processors 102, the memory 104, the non-transitory computer-readable storage medium 108, and one or more output devices 112.

In some embodiments, the device or computer system 100 can further comprise one or more output devices 112, which can be configured to send or receive information to or from any one from the group consisting of: an external device (not shown in FIG. 1), the one or more processors 102, the memory 104, and the non-transitory computer-readable storage medium 108.

In accordance with, for example, claim 1, method for providing a recommendation for a product within a set of products to a user belonging to a group of a plurality of users within a larger set of users each user having unique user identification information and each product having unique product identification information, the method:

obtaining from the set of users product reviews of at least some of the products within the set of products;

storing the reviews in a database along with corresponding product identification information and the user identification information of the user providing the review;

allocating each user within the set of users to a group within a plurality of groups based upon the product reviews provided by the users; and providing a recommendation to a user within a group based upon reviews of other members of the group.

Each of the above identified steps, modules or programs corresponds to a set of instructions for performing a function described above. These modules and programs (i.e., sets of instructions) need not be implemented as separate software programs, procedures or modules, and thus various subsets of these modules may be combined or otherwise re-arranged in various embodiments. In some embodiments, memory may store a subset of the modules and data structures identified above. Furthermore, memory may store additional modules and data structures not described above.

The illustrated aspects of the disclosure may also be practiced in distributed computing environments where certain tasks are performed by remote processing devices that are linked through a data communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems, circuits and modules are described herein with respect to interaction between several components or blocks. It can be appreciated that such systems, circuits and modules circuits and components or blocks can include those components or specified subcomponents, some of the specified components or sub-components, and/or additional components, and according to various permutations and combinations of the foregoing. Subcomponents can also be implemented as components communicatively coupled to other components rather than included within parent components. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include tangible computer-readable storage media and/or communications media, in which these two terms are used herein differently from one another as follows. Tangible computer-readable storage media can be any available storage media that can be accessed by the computer, is typically of a non-transitory nature, and can include both volatile and nonvolatile media, removable and non-removable media. By way of example, and not limitation, tangible computer-readable storage media can be implemented in connection with any method or technology for storage of information such as computer-readable instructions, program modules, structured data, or unstructured data. Tangible computer-readable storage media can include, but are not limited to, RAM (random access memory), ROM (read-only memory), PROM (programmable read-only memory), EEPROM (electrically eraseable programmable read-only memory), flash memory, jump drives, USB (universal serial bus) drives (and the like) or other memory technology, compact disk (CD and CD-ROM), digital versatile disk (DVD and DVD-ROM), paper card, paper tape or other information storage media, magnetic cassettes, magnetic tape, magnetic disk storage or other magnetic storage devices, or other tangible and/or non-transitory media which can be used to store desired information. Tangible computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be appreciated that the methodologies disclosed in this specification are capable of being stored on an article of manufacture to facilitate transporting and transferring such methodologies to computing devices. The term article of manufacture, as used herein, is intended to encompass a computer program accessible from any computer-readable device or storage media.

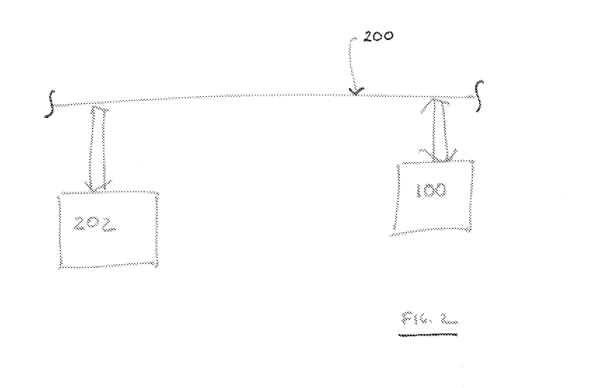

FIG. 2 is a system block diagram illustrating a portion of a data communications network coupling a computer system to a user's computer. This is a typical scenario wherein a computer system 100 such as a web server provides computer functionality to a user's computer 202 over a data communications network 200 such as the Internet. The user's computer 202 may be coupled via wires and/or wirelessly to the data communications network 200 so that the user may access the computer system 100.

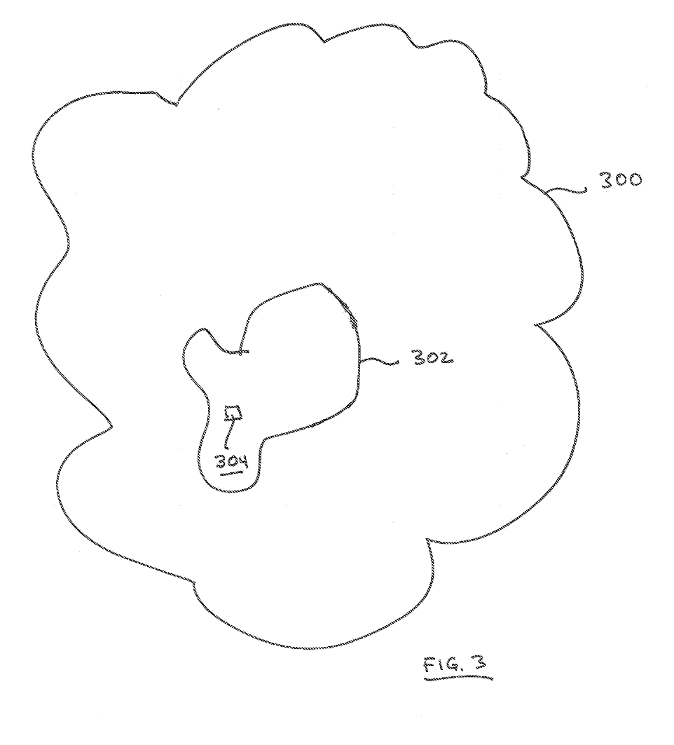

FIG. 3 is a Venn diagram illustrating the universe of uniquely identifiable products 300, a subset, class or group of products within that universe 302, and an individual product 304. In accordance with one embodiment a class or group of products constituting a subset of all products is to be reviewed. For example, such a class, group or subset may be a food or drink item such as wine, or some subset of wines, or some other product subset, depending upon how one wants to set the system up. It is not considered optimal to include all products (although in principal it could be done) because there is no reason to believe that peoples' tastes are highly correlated in any way across product classifications, e.g., one's taste for wine may have no relationship to one's taste for sports cars. As used herein the term “product” is intended, without limitation, to encompass products, services, business establishments and the like.

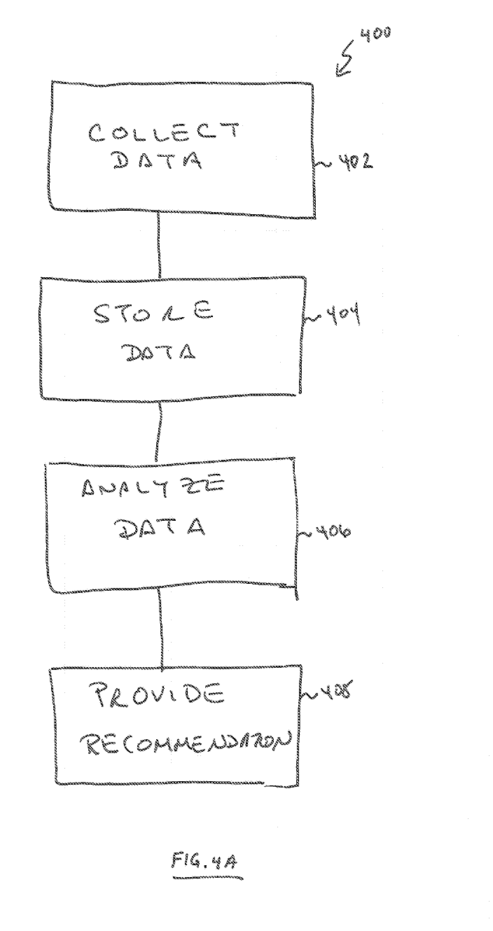

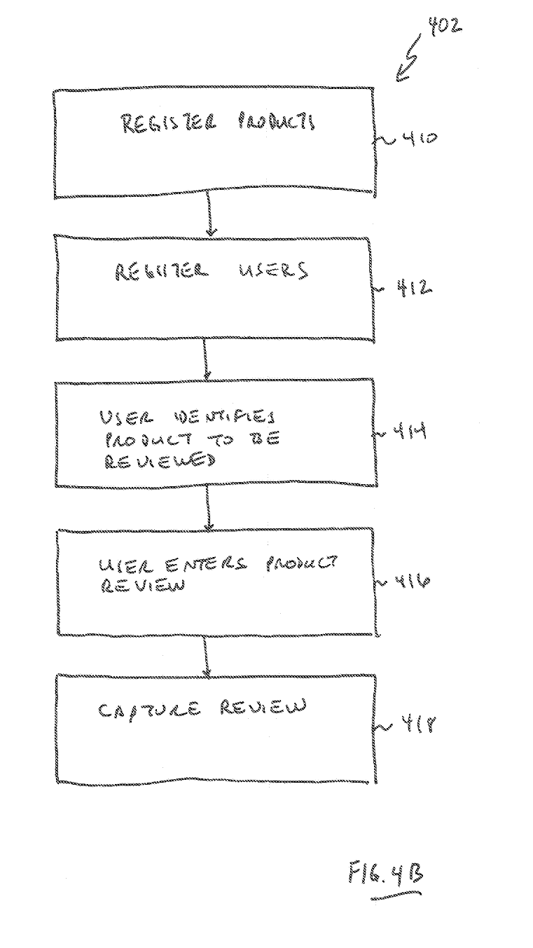

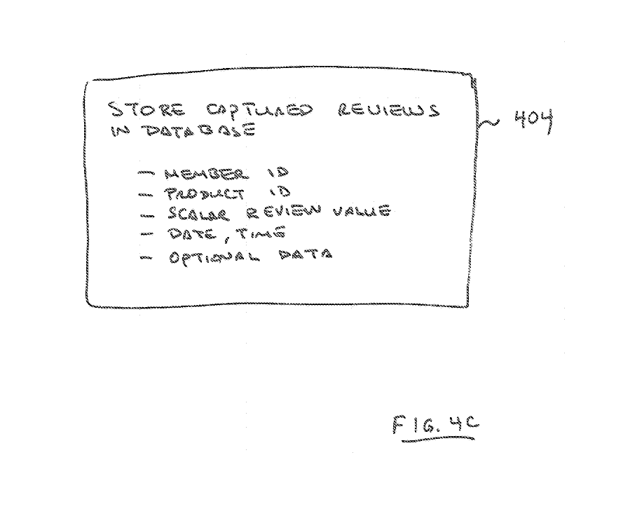

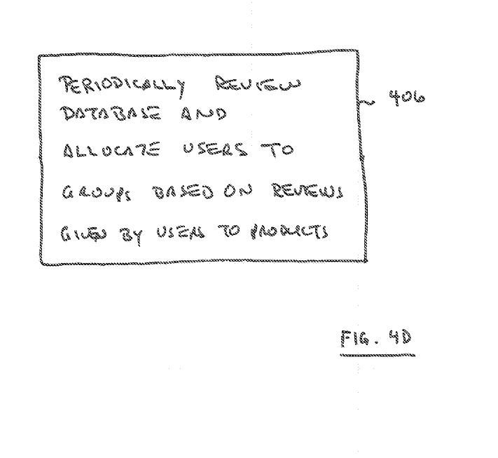

FIG. 4A is a process flow chart illustrating the basic flow of the process detailed herein. In FIG. 4A the basic process 400 is illustrated in flow diagram form. Data is collected at step 402. Data is stored at step 404. Data is analyzed at step 406 and a recommendation is provided to a user at step 408.

FIG. 4B (402) is a process flow diagram illustrating the basic collection of data used in the process of FIG. 4A. At step 410 the unique identification information of products in the set of products to be reviewed is registered in the database. This process can continue from time to time as additional products are added to the database. This step effectively sets the breadth of the product class subject to review by including and disincluding various products. Typically this step would be accomplished by the manager of the database although it is possible to allow users to add products to the database with or without oversight, if desired. At step 412 users are registered and assigned unique identification information such as a conventional user ID. This process can continue from time to time as new users join. At step 414 users enter product reviews. This is done by uniquely identifying a product within the database and providing a unique user ID and a product review value. For example, one might scan a UPC (universal product code) label to uniquely identify the product, or type in a product number, or identify the product from a pull down list, or the like. At step 416 the user enters the product review value. The product review value may be a number, a statement selected from a pull down menu, a letter grade, or other indicator constrained by the system so that it can later be converted to a scalar (numerical) value, e.g., 1-5, 1-10, 1-100 and the like (i.e., the product review value is “scalar in nature”). At step 418 the product review value is converted to a standardized scalar value for storage in the database.

FIG. 4C (404) is a process flow diagram illustrating the basic storage of data used in the process of FIG. 4A. At step 404 the captured scalar review value from step 418 is stored in the database along with other pertinent information such as: the unique identification information associated with the product reviewer (e.g., the user ID), the unique product identification information of the product being reviewed, optionally the date and time of the review, and optionally other pertinent information such as information to further verify the identity of the reviewer (e.g., I.P. Address and the like).

FIG. 4D (406) is a process flow diagram illustrating the basic analysis of data used in the process of FIG. 4A. Data analysis in accordance with step 406 is intended to allocate individual users to individual groups of users. Thus each user will be allocated to a group and be a member of that group until reallocated by a subsequent allocation step. Each group of users will contain at least two users and in practice a large plurality of users. Periodically the user database is reviewed and a reallocation occurs. Users are allocated to one group at any time. The allocation of users to groups is determined by execution of an algorithm generally referred to as a “clustering algorithm”. Such a clustering algorithm may be implemented in a number of ways.

First, the product review values given to identical products by different users may be compared in a multi-dimensional space and users who, in that multi-dimensional space, are relatively “close” to one another in terms of their ratings of similar and identical products in a Euclidean sense are grouped together. Because outliers can cause this approach to have too many lowly populated groups for a given number of users it may be desirable to constrain the formation of groups to certain numbers of groups, certain minimum group sizes, and the like. This process may be carried out manually, automatically or semi-automatically depending upon the database software system implemented.

Second, a K-Means clustering algorithm may be used on the multi-dimensional data in the product review database to determine “clusters” of users giving similar reviews for identical products and allocate those users to groups based upon the similarity of the reviews given. In effect this approach allocates users with similar “taste” to the same groups.

Third, a stepwise approach may be used to allocate users to groups. In this approach, described in more detail below, users who have given an identical product or products similar reviews are allocated to the same groups.

All of these foregoing approaches to user to group allocation are supported by conventional multi-dimensional database software products currently available on the market from vendors such as Oracle Corporation of Redwood City, Calif., Microsoft Corporation of Redmond, Wash., and International Business Machines Corporation or Armonk, N.Y., as well as others. Open Source versions of such database engines are also available from the Open Source software community.

FIG. 4E (408) is a process flow diagram illustrating the basic recommendation process used in the process of FIG. 4A. First, a user may provide a query to the system requesting a recommendation of a product. The query may be submitted over the data communications network 200 to the computer 100 from the user's computer 202. The query may be constrained in a number of ways, with, for example, selection criteria such as drop down lists, check off boxes or natural language limitations. For example the query may be limited to a certain price range or may set upper and/or lower price cutoffs. It may specify certain types of product or product made by a certain subset of manufacturers. It may specify locale of manufacture and the like. For example, with wine one could specify one or more appellations, types of wine, wineries, vintages, and so on. The system then looks at product reviews provided by users within the same group as the user submitting the query and makes a recommendation of one or more products meeting any selection criteria given and ranked by average (optionally weighted) product review values given by the members of the group. In this way users who have similar tastes in the product in question effectively provide the recommendation to the user rather than all users at once. One, several or all recommended products may be displayed to the user submitting the query.

Second, the system may be configured, given knowledge of the user's user ID, to “push” recommendations of relevant products to the user without the need for a specific query. This approach to “push” notifications is frequently used today at various web sites on the Internet.

Optionally, recommendations for products already reviewed by the user may be omitted from recommendations transmitted to the user.

At steps 416, 418 and 404 it is possible to “weight” the product review made by a particular user or class of users. For example, a user with many reviews given over a long period of time may receive a higher weight value than one with less experience. The weighting may be implemented in a number of ways as will be apparent to those of ordinary skill in the art. For example, the weighting may be implemented by multiplying the product review value by a weight value of 0 to 1 with 0 according no weight and 1 according full weight. In calculating the average product review value for the product given by the group this would be taken into account. An example would be where an experienced user (say with 1000 reviews given) is given a weight of 1.0, a moderately experienced user (say with 100-999 reviews given) is given a weight of 0.75 and an inexperienced user (say with 0-99 reviews given) is given a weight of 0.5. In such a case if three ratings were given as follows:

| User | Review Value | Weight |
|---|---|---|
| Experienced | 75 | 1.0 |
| Moderate | 60 | 0.75 |
| Inexperienced | 80 | 0.50 |

Then the average product review value would be [(75*1.0)+(60*0.75)+(80*0.50)]/3=53.33. Many similar but potentially somewhat different approaches to achieve user weighting will now be apparent to those of ordinary skill in the art. Weighting may also be based upon fees paid for membership status rather than experience, or some combination thereof, or by other criteria as determined by the system manager.

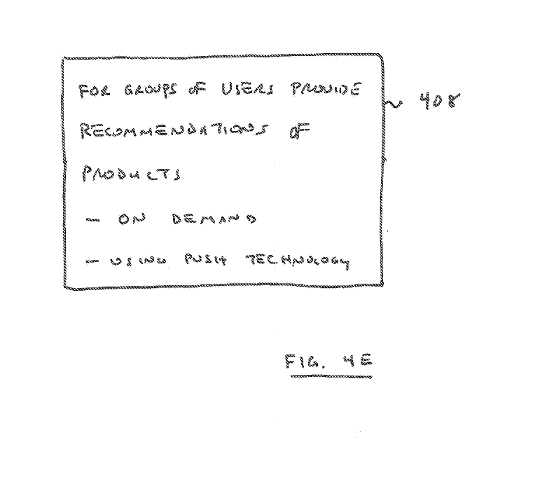

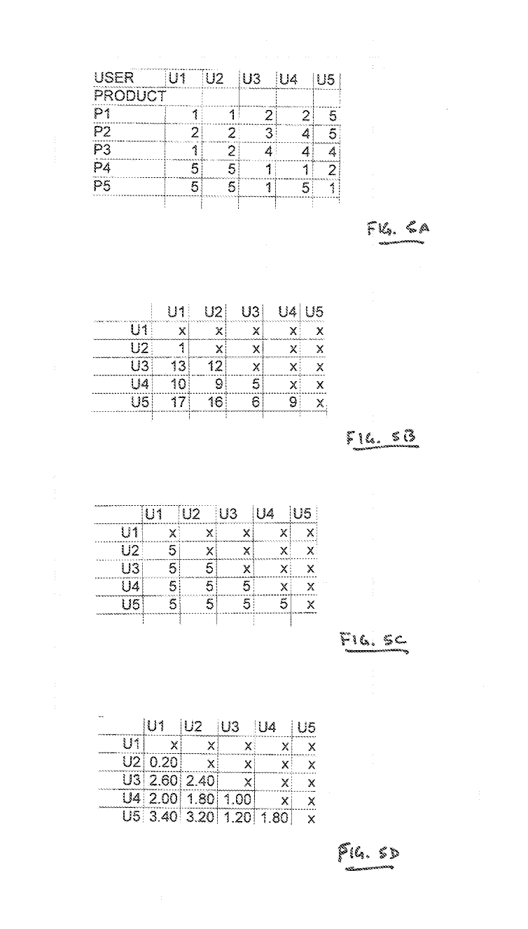

FIG. 5A is an exemplary simplified User-Product Data Matrix in accordance with an embodiment. Turning to FIGS. 5A-5D a simplified example of allocation of users to groups is illustrated in more detail. In the example of FIGS. 5A-5D there are five users: U1, U2, U3, U4 and U5. There are five products to review: P1, P2, P3, P4 and P5. Products are reviewed with a scalar reviewing system 1-5. FIG. 5A shows the reviews given by Users U1-U5 to Products P1-P5.

FIG. 5B is an Un-Normalized User-User Distance Matrix in accordance with an embodiment. For example, the “distance” between U1 and U2 is the summation from i=1 to i=n of the absolute value of U1i-U2i. In this case that value is 1 because U1 and U2 gave the same reviews for 4 of the 5 products and only differed on one product by 1 unit. Similarly the “distance” between U1 and U5 is 17 because the reviews differ markedly for all products.

FIG. 5C is a matrix illustrating User In-Common reviews in accordance with an embodiment. This represents the numbers of reviews for the same product that each user made. In this example each user reviewed all 5 products.

FIG. 5D is a User-User Normalized Distance Matrix in accordance with an embodiment. In effect this matrix is the matrix of FIG. 5B divided by the matrix of FIG. 5C. This matrix is representative of the “distance” between user preferences as represented by the product review values submitted by users. Here U1 and U2 are very close, i.e., 0.2, and would likely be placed in the same group by a clustering algorithm or other approach seeking users with similar “taste”. U1 and U5 are relatively far apart and would likely not be placed in the same group. Note that in FIGS. 5B-5D the positions shown with the value “x” are simply irrelevant or redundant (e.g., the U1-U1 distance will always be 0 and the U1-U2 distance will always be the same as the U2-U1 distance).

Another way to look at this on a small scale is to think of similar ratings as bonds of trust. The trust bonds developed between and among users within a group are actually real-time, iterative, attractive and repulsive relationships dynamically expressing the degree to which members express the same degree of like or dislike for a product. For example, take three people (A, B, C) and four wines (1-4) and look at how simple preference selection can establish trust bonds. Note that this example exists only in two dimensions. In practice, trust bonds and relationships within the system will function in higher ordered dimensions.

In the current example:

<A> has tried wine 1 and wine 2: [W1] and [W2] and provided a product review value of 5/5 to each.
<B> has tried wine 2 and wine 3: [W2] and [W3] and provided a product review value of 5/5 to each.
<C> has tried wine 3 and wine 4: [W3] and [W4] and provided a product review value of 5/5 to each.
Thus, <A> and <B> have both reviewed [W2] and like it equally.
The system also recognizes that both <A> and <B> have tried different wines within the same product set. Accordingly, it issues recommendations:
<A> receives a recommendation that [W3] may be a good wine to try.
<B> receives a recommendation that [W1] may be a good wine to try.
Now if <A> and <B> both try the recommended wines and review them similarly, binds are strengthened, if dissimilarly, bonds are weakened.

Now, continuing with the example:

<C> has tried and likes wines [W3] and [W4] and has provided a product review value of 5/5.
<B> also likes [W3] the same as <C>
Therefore the system will recommend that <C> try [W2] and <B> try [W4].
<B> and <C> try and rate the recommended wines.
Again, bonds are strengthened or weakened depending upon the reviews expressed after trying the recommended product in response to the recommendations.

While exemplary embodiments and applications have been shown and described, it would be apparent to those skilled in the art having the benefit of this disclosure that numerous modifications, variations and adaptations not specifically mentioned above may be made to the various exemplary embodiments described herein without departing from the scope of the invention which is defined by the appended claims.

What is claimed is:

1. A method for providing a recommendation for a product within a set of products to a user belonging to a group of a plurality of users within a larger set of users each user having unique user identification information and each product having unique product identification information, the method comprising:
obtaining from the set of users product reviews of at least some of the products within the set of products;
storing the reviews in a database along with corresponding product identification information and the user identification information of the user providing the review;
allocating each user within the set of users to a group within a plurality of groups based upon the product reviews provided by the users; and
providing a recommendation to a user within a group based upon reviews of other members of the group.

2. The method of claim 1 wherein the providing is performed in response to a query to a server on a data communications network by the user.

3. The method of claim 1 wherein the providing is performed automatically without a specific query by the user.

4. The method of claim 1, wherein the allocating of the users is performed periodically.

5. The method of claim 4, wherein the allocating of the users uses a predetermined target number to determine approximately the number of users to place in each group.

6. The method of claim 4, wherein the allocating of the users uses a predetermined target number to determine approximately the number of groups to which to allocate users.

7. The method of claim 4, wherein the allocating of the users to groups is performed with a k-means clustering algorithm.

8. The method of claim 4, wherein the product reviews obtained from the users are scalar in nature.

9. The method of claim 5, wherein the allocating of users to groups includes calculating a multi-dimensional Euclidean rating distance between users who have reviewed identical products and allocating users to groups based on the calculated distance.

10. A computer program product for providing a product recommendation for a product within a set of a plurality of products to a user in a group of a plurality of users, the computer program product comprising:
a computer readable storage medium having computer readable code embodied therewith, the computer readable code comprising:
computer readable program code configured to receive product reviews for a plurality of products within a product class from a plurality of users;
computer readable program code configured to, based upon the product reviews given by the users, allocate each user to one of a plurality of groups;
computer readable program code configured to provide a product recommendation to a member of a group of users based upon reviews given the product by other members of the same group of users.

11. The computer program product according to claim 10, wherein the clustering of the users into a plurality of groups is done periodically.

12. The computer program product according to claim 11, wherein the clustering of the users into a plurality of groups uses a predetermined target number to determine approximately the number of users to place in each group.

13. The computer program product according to claim 11, wherein the clustering of the users into a plurality of groups users a k-means algorithm to place the users in groups.

14. The computer program product according to claim 11, wherein the product reviews given by the users to products are scalar in nature.

15. The computer program product according to claim 14, wherein the allocation of users to groups includes calculating a multi-dimensional Euclidean review distance between users who have submitted reviews for identical products and allocating users to groups based on the calculated distance.

16. The computer program product according to claim 11, wherein the product recommendation is provided in response to a query to a server on a data communications network by the user.

17. The computer program product according to claim 11, wherein the product recommendation is provided automatically without a specific query by the user.

18. A system for providing a product recommendation for a product within a set of a plurality of products to a user in a group of a plurality of users, the system comprising:
one or more processors; and
a memory operatively coupled to the one or more processors;
wherein, responsive to execution of computer readable program code accessible to the one or more processors, the one or more processors are configured to:
receive product reviews for a plurality of products within a product class from a plurality of users;
based upon the product reviews given by the users, allocate each user to one of a plurality of groups; and
provide a product recommendation to a member of a group of users based upon reviews given the product by other members of the same group of users.

19. The system of claim 18, wherein the product reviews given by the users to products are scalar in nature.

20. The system of claim 19, wherein the allocation of users to groups includes calculating a multi-dimensional Euclidean rating distance between users who have submitted product reviews for identical products and allocating users to groups based on the calculated distance.
